(19) United States
(12) Patent Application Publication
(10) Pub. No.: US 2026/0029826 A1
(43) Pub. Date: Jan. 29, 2026

(54) ACCESSORY DEVICE INCLUDING PLURALITY OF MAGNETS

(71) Applicant: SAMSUNG ELECTRONICS CO., LTD., Suwon-si (KR)

(72) Inventors: Namhyun KANG, Suwon-si (KR); Minah KOH, Suwon-si (KR)

(73) Assignee: SAMSUNG ELECTRONICS CO., LTD., Suwon-si (KR)

(21) Appl. No.: 19/343,691

(22) Filed: Sep. 29, 2025

Related U.S. Application Data
(63) Continuation of application No. PCT/KR2023/021960, filed on Dec. 29, 2023.

(30) Foreign Application Priority Data
Mar. 31, 2023 (KR) 10-2023-0042613
Apr. 12, 2023 (KR) 10-2023-0048022

(51) Int. Cl. G06F 1/16

(52) U.S. Cl. CPC G06F 1/1669; G06F 1/1679

(57) ABSTRACT

An accessory device that is detachable from an electronic device includes a first housing including a first case configured to accommodate a first portion of the electronic device, a second case configured to accommodate a second portion of the electronic device, and a hinge rotatably connecting the first case to the second case, a second housing including an electronic module configured to be connected to the electronic device, and a fastening assembly configured to detachably couple the first housing to the second housing, where the fastening assembly includes a plurality of first magnets arranged in a first end portion of the second case facing the hinge and a plurality of second magnets in a first end portion of the second housing and respectively arranged to face the plurality of first magnets.

### CROSS-REFERENCE TO RELATED APPLICATIONS

This application is a continuation of International Application No. PCT/KR2023/021960, filed on Dec. 29, 2023, in the Korean Intellectual Property Receiving Office, which is based on and claims priority to Korean Patent Application No. 10-2023-0042613, filed on Mar. 31, 2023, in the Korean Intellectual Property Office, and Korean Patent Application No. 10-2023-0048022, filed on Apr. 12, 2023, in the Korean Intellectual Property Office, the disclosures of which are incorporated by reference herein in their entireties.

### BACKGROUND

### 1. Field

The disclosure relates to an accessory device including a plurality of magnets.

### 2. Description of Related Art

Various types of electronic devices, such as smartphones, tablet personal computers (PCs), or laptops, are becoming widespread, and an accessory device that is coupled to or capable of interoperating with an electronic device is being developed.

For example, an accessory device may be a case that is physically coupled to the exterior of an electronic device and protects the electronic device or a stand for mounting the electronic device on an external support, or the accessory device may be an input device or output device that is electrically connected to the electronic device.

To improve the convenience of an electronic device or expand the usability of the electronic device, the demand for an accessory device with various functions is increasing.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide an accessory device that may change the usage aspect of an electronic device according to the usage environment and expand the convenience and usability of a user.

Additional aspects will be set forth in part in the description which follows and, in part, will be apparent from the description, or may be learned by practice of the presented embodiments.

According to an aspect of the disclosure, an accessory device that is detachable from an electronic device may include a first housing including a first case configured to accommodate a first portion of the electronic device, a second case configured to accommodate a second portion of the electronic device, and a hinge rotatably connecting the first case to the second case, a second housing including an electronic module configured to be connected to the electronic device, and a fastening assembly configured to detachably couple the first housing to the second housing, where the fastening assembly may include a plurality of first magnets arranged in a first end portion of the second case facing the hinge and a plurality of second magnets in a first end portion of the second housing and respectively arranged to face the plurality of first magnets.

The plurality of first magnets may be spaced apart from each other, and one of the plurality of first magnets is polarized in a direction opposite to an adjacent first magnet.

Each of the plurality of first magnets may include a magnet in a cylindrical shape extending along an end portion of the second case.

Each of the plurality of first magnets may be polarized in both directions based on a cross-section horizontal to a height direction of the cylindrical shape.

Each of the plurality of first magnets may be polarized in both directions based on a cross-section perpendicular to a height direction of the cylindrical shape.

The first housing may include a guide member to which at least a portion of the plurality of first magnets is fixed and a guide groove configured to accommodate the guide member, and, inside the guide groove, the guide member may be disposed to be movable in a first direction toward the first end portion of the second case or a second direction opposite to the first direction.

The first housing may include an elastic member configured to be pressed when the guide member moves in the first direction and a locking member connected to the guide member and configured to fix or release the electronic device and the second case based on movement of the guide member.

The locking member may be further configured to release a fixation of the electronic device and the second case when the guide member is moved by at least one of the plurality of first magnets in the first direction, and fix the electronic device and the second case when the guide member is moved by the elastic member in the second direction.

The first housing may include a switch configured to move the guide member.

The accessory device may include a slide assembly configured to support the electronic module to be slidable in a slide direction from a first end portion of the accessory device in which the plurality of second magnets is disposed toward a second end portion of the accessory device opposite to the first end portion or in an opposite direction, and the slide assembly may include a fixing member in the second housing and a guide rail in the electronic module, configured to accommodate the fixing member, and extending in the slide direction.

The second housing may include a restoring member configured to be pressed when the electronic module moves in the slide direction, the restoring member including an elastic material.

The accessory device may include a plurality of wheels between the second housing and the electronic module.

The electronic module may include a first sub-magnet and the second housing may include a second sub-magnet configured to face the first sub-magnet based on a state before the electronic module slides.

The first housing may include a first fastening assembly in a surface facing the electronic device in the first case and configured to support the electronic device and a second fastening assembly configured to support an external auxiliary connecting device.

The accessory device may include at least one marker in the second case and configured to electromagnetically change according to a distance from the electronic device.

According to an aspect of the disclosure, an accessory device that is detachable from an electronic device may include a first case configured to accommodate a first portion of the electronic device, a second case configured to accommodate a second portion of the electronic device, a hinge rotatably connecting the first case to the second case and a plurality of magnets in a first end portion of the second case facing the hinge, where the plurality of magnets are spaced apart from each other and a first magnet of the plurality of magnets is polarized in a direction opposite to a second magnet of the plurality of magnets that is adjacent to the first magnet.

Each of the plurality of magnets may include a magnet in a cylindrical shape extending along an end portion of the second case.

Each of the plurality of magnets may be polarized in both directions based on a cross-section horizontal to a height direction of the cylindrical shape.

The accessory device may include a guide member to which at least a portion of the plurality of magnets is fixed, and a guide groove configured to accommodate the guide member, where, inside the guide groove, the guide member is disposed to be movable in a first direction toward the first end portion of the second case or a second direction opposite to the first direction.

The accessory device may include an elastic member configured to be pressed when the guide member moves in the first direction and a locking member connected to the guide member and configured to fix or release the electronic device and the second case based on a movement of the guide member, where the locking member is further configured to release a fixation of the electronic device and the second case when the guide member is moved by at least one of the plurality of magnets in the first direction and fix the electronic device and the second case when the guide member is moved by the elastic member in the second direction.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment, according to various embodiments;

FIG. 2 is a perspective view of an electronic device and an accessory device, according to an embodiment;

FIG. 3A is a diagram illustrating the usage aspect of an accessory device equipped with an electronic device, according to an embodiment;

FIG. 3B is a diagram illustrating the usage aspect of an accessory device equipped with an electronic device, according to an embodiment;

FIG. 3C is a diagram illustrating the usage aspect of an accessory device equipped with an electronic device, according to an embodiment;

FIG. 3D is a diagram illustrating the usage aspect of an accessory device equipped with an electronic device, according to an embodiment;

FIG. 3E is a diagram illustrating the usage aspect of an accessory device equipped with an electronic device, according to an embodiment;

FIG. 3F is a diagram illustrating the usage aspect of an accessory device equipped with an electronic device, according to an embodiment;

FIG. 4A is an exploded perspective view of an electronic device and an accessory device, according to an embodiment;

FIG. 4B is an enlarged perspective view of an accessory device according to an embodiment;

FIG. 4C is a schematic diagram illustrating a plurality of magnets of an accessory device, according to an embodiment;

FIG. 4D is an enlarged perspective view of an accessory device according to an embodiment;

FIG. 5A is a plan view of an accessory device equipped with an electronic device, according to an embodiment;

FIG. 5B is a plan view of an accessory device equipped with an electronic device, according to an embodiment;

FIG. 6A is a plan view of an accessory device equipped with an electronic device, according to an embodiment;

FIG. 6B is a plan view of an accessory device equipped with an electronic device, according to an embodiment;

FIG. 7A is a side view of an accessory device equipped with an electronic device, according to an embodiment;

FIG. 7B is a plan view of a second housing according to an embodiment;

FIG. 8A is a side view of an accessory device equipped with an electronic device, according to an embodiment;

FIG. 8B is a plan view of a second housing according to an embodiment;

FIG. 9A is a rear view of an accessory device equipped with an electronic device, according to an embodiment;

FIG. 9B is a side view of an accessory device according to an embodiment;

FIG. 10A is a rear view of an accessory device equipped with an electronic device, according to an embodiment; and

FIG. 10B is a side view of an accessory device according to an embodiment.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted. The embodiments described herein are example embodiments, and thus, the disclosure is not limited thereto and may be realized in various other forms.

It should be appreciated that various embodiments of the disclosure and the terms used therein are not intended to limit the technical features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “at least one of A, B, or C”, each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments may be implemented as software (e.g., the program 140) including one or more instructions that are stored in a storage medium (e.g., internal memory 136 or external memory 138) that is readable by a machine (e.g., an electronic device). For example, a processor of the machine (e.g., the electronic device) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments disclosed herein may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

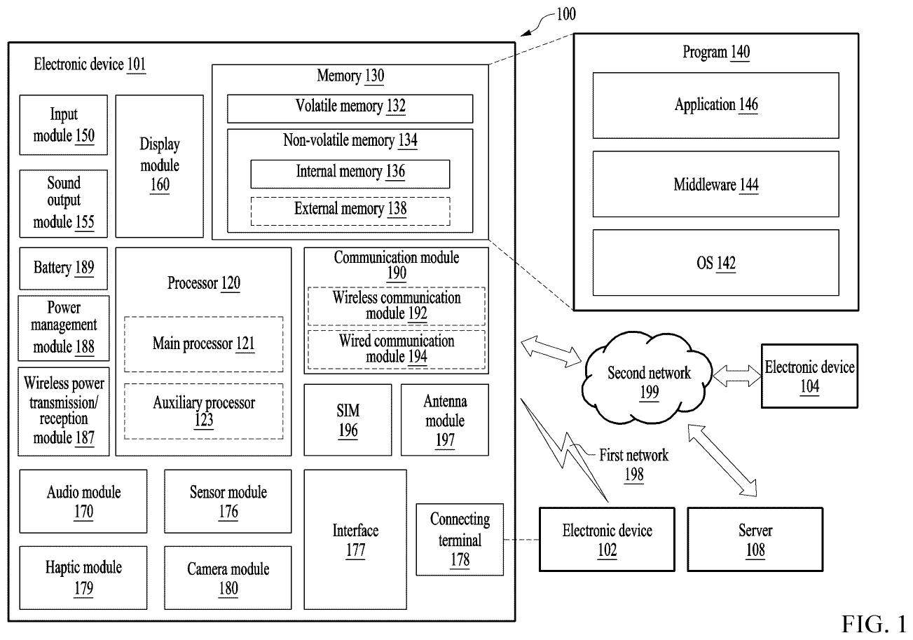

FIG. 1 is a block diagram illustrating an electronic device 101 in a network environment 100, according to various embodiments. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the above components may be omitted from the electronic device 101, or one or more other components may be added to the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an embodiment, as at least a portion of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence (AI) model processing. The AI model may be generated by machine learning. The machine learning may be performed by, for example, the electronic device 101, in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 130 may store various data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a record. The receiver may be used to receive an incoming call. According to an embodiment, the receiver may be implemented separately from the speaker or as a portion of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to sense a touch, or a pressure sensor adapted to measure an intensity of a force incurred by the touch.

The audio module 170 may convert a sound into an electric signal and vice versa. According to an embodiment, the audio module 170 may obtain the sound via the input module 150 or output the sound via the sound output module 155 or an external electronic device (e.g., an electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a portion of a power management integrated circuit (PMIC). The wireless power transmission/reception module 187 may be configured to transmit and receive power wirelessly.

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a fourth generation (4G) network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device). According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mm Wave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. According to an embodiment, all or some of operations to be executed at the electronic device 101 may be executed at one or more of external electronic devices (e.g., the external devices 102 and 104, and the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To this end, cloud computing, distributed computing, mobile edge computing (MEC), or client-server computing technology may be used, for example. The electronic device 101 may provide ultra low-latency services using, e.g., distributed computing or MEC. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic device is not limited to those described above.

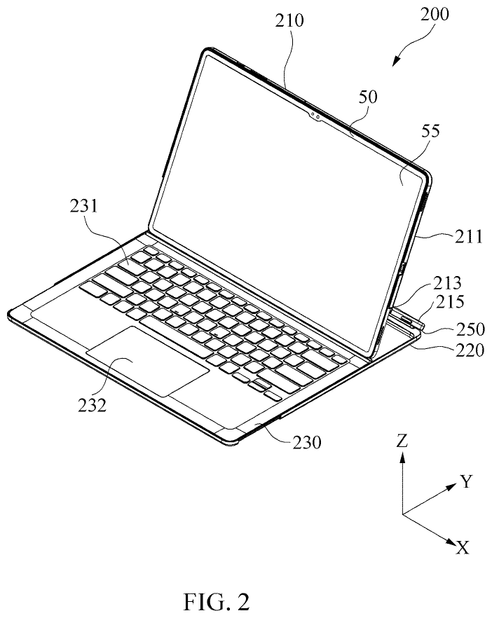

FIG. 2 is a perspective view of an electronic device 50 and an accessory device 200, according to an embodiment.

Referring to FIG. 2, the accessory device 200 according to an embodiment may be detachable from the electronic device 50.

In an embodiment, the accessory device 200 may be a separate device that is detachable from the electronic device 50. Alternatively, the accessory device 200 is a portion of the configuration of the electronic device 50 and may be a detachable-associated device according to the usage environment of the electronic device 50.

In an embodiment, the accessory device 200 may be the electronic device 101 of FIG. 1, and the electronic device 50 may be the electronic device 102 of FIG. 1. Alternatively, the accessory device 200 may be the electronic device 102 of FIG. 1, and the electronic device 50 may be the electronic device 101 of FIG. 1. Hereinafter, the description provided with reference to FIG. 1 is not repeated, and in some embodiments, a portion of the configuration and structure of the electronic device 50 and the accessory device 200 may be replaced, added, or omitted as will be understandable by one of ordinary skill in the art with reference to the following drawings and descriptions. In addition, at least one component or feature of the embodiments described above may be coupled to the electronic device 50 and the accessory device 200 unless this is technically and clearly infeasible.

In an embodiment, the electronic device 50 may be a tablet personal computer (PC) device, as illustrated in the drawing, or may be a display device including a display module 55 or a wireless communication device.

For example, the electronic device 50 may be a display device, such as a smartphone including a rollable display or a foldable display, or a wireless communication device. Without being limited thereto, the electronic device 50 according to an embodiment of the present disclosure may be a device of various types and shapes as a device mountable with the accessory device 200.

In an embodiment, the accessory device 200 may be a cover or case for protecting the exterior of the electronic device 50, a standing device for mounting the electronic device 50 on an external support or for expanding the usability, and/or a device for expanding the usability of the electronic device 50 by including an electronic module 230 connectable to the electronic device 50.

In an embodiment, the accessory device 200 may include the electronic module 230 connectable to the electronic device 50. The electronic module 230 may expand the usability of the electronic device 50 and/or provide convenience of use.

The electronic module 230 according to an embodiment may be an input device including at least one of a keyboard 231 and a touchpad 232. However, this is an example, and the electronic module 230 may be implemented as a device having various functions.

For example, the electronic module 230 may be an output device for outputting sound and/or screens, a power device for providing power to the electronic device 50, and/or a communication device for communicating with the electronic device 50 and an external device. Hereinafter, for ease of description, an example in which the electronic module 230 is implemented as an input device including a keyboard and a touchpad is provided, but embodiments are not limited thereto.

In an embodiment, the accessory device 200 may include a first housing 210 and a second housing 220. The first housing 210 may be a housing or body for accommodating or supporting the electronic device 50, and the second housing 220 may be a housing or body for accommodating or supporting the electronic module 230. The first housing 210 and the second housing 220 may be connected by a fastening assembly 250.

In an embodiment, the electronic device 50 may be detachable from the first housing 210. When the electronic device 50 is connected to the first housing 210, the electronic module 230 is structurally/electrically/communicatively linked to the connection operation so that the electronic module 230 and the electronic device 50 may be interconnected. The first housing 210 may include at least a portion of a first case 211, a hinge 213, and a second case 215. Hereinafter, an example of the structure or operation of the accessory device 200 according to an embodiment of the present disclosure is described with reference to the drawings.

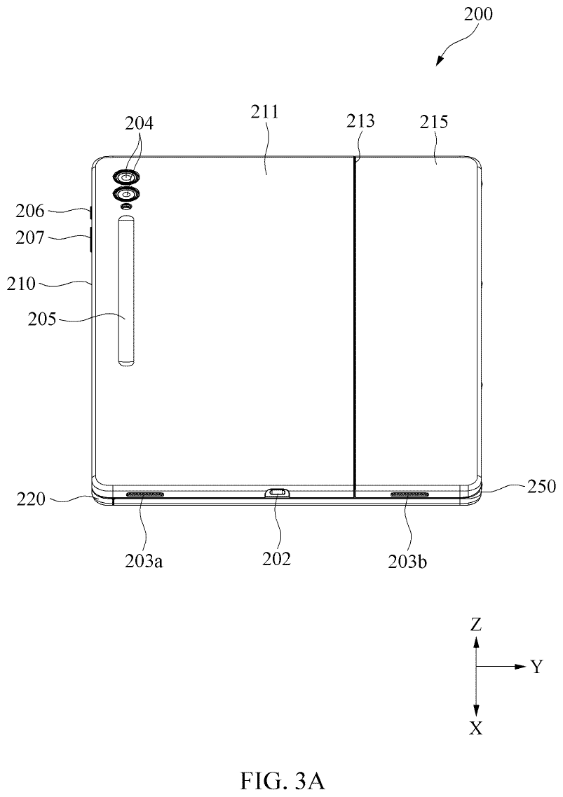

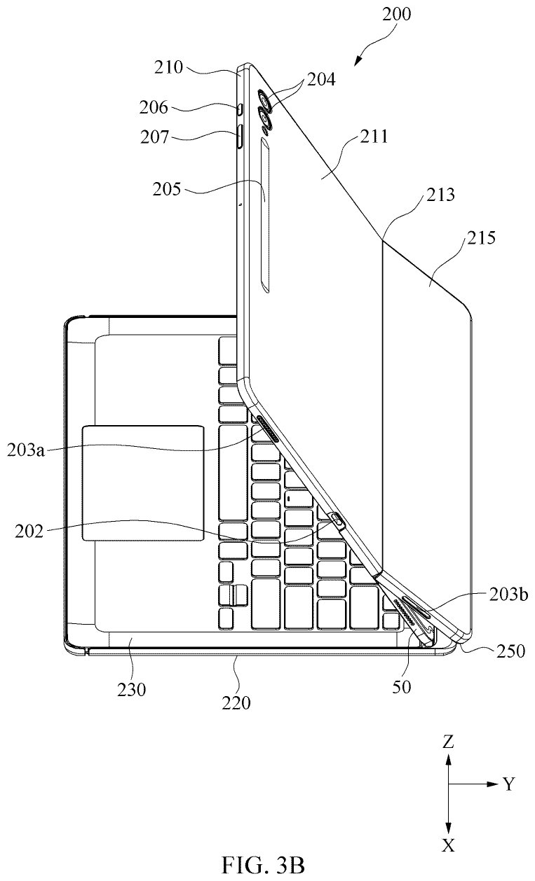

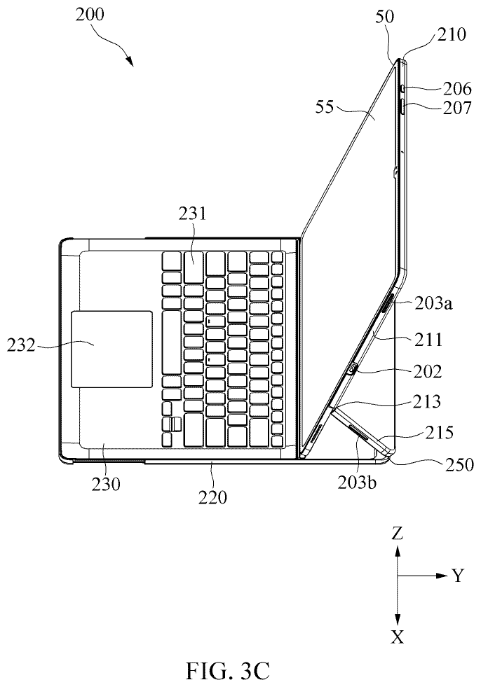

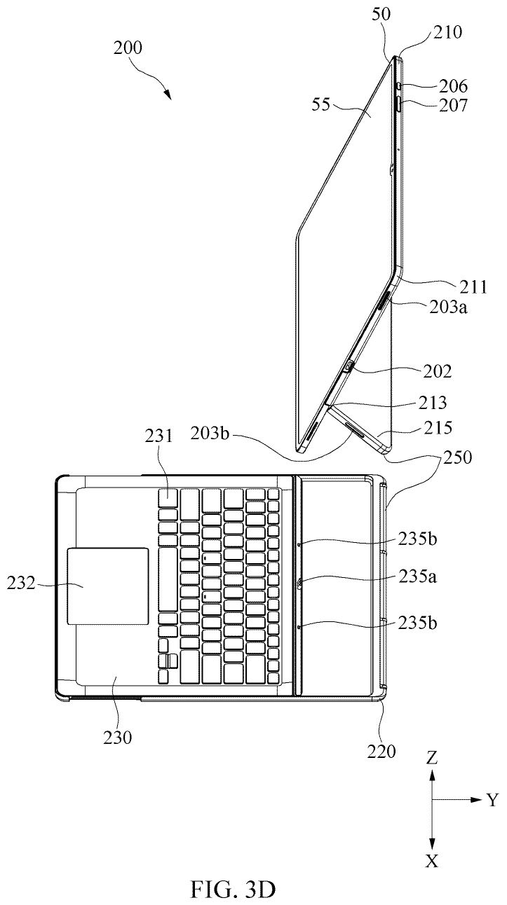

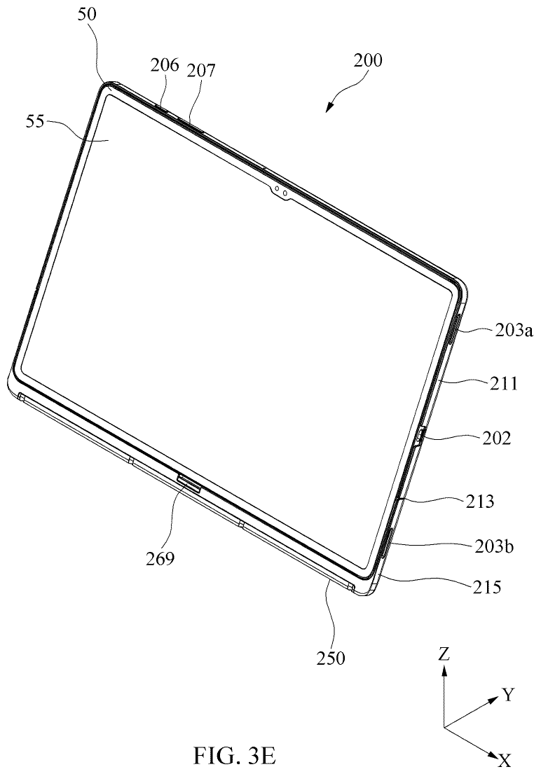

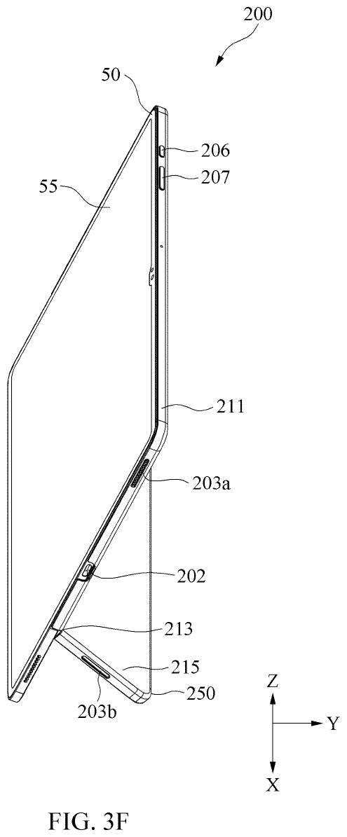

FIGS. 3A, 3B, 3C, 3D, 3E, and 3F each illustrate a diagram illustrating the usage aspect of the accessory device 200 equipped with the electronic device 50, according to an embodiment.

Specifically, FIGS. 3A, 3B, and 3C are diagrams illustrating an open process of the first housing 210 and the second housing 220 of the accessory device 200, and FIGS. 3D, 3E, and 3F are diagrams illustrating an example of an operation of separating and using the first housing 210 of the accessory device 200 from the second housing 220.

Hereinafter, the description provided above is not repeated, and in some embodiments, a portion of the configuration and structure of the accessory device 200 may be replaced, added, or omitted as will be understandable by one of ordinary skill in the art with reference to the following drawings and descriptions. In addition, at least one component or feature of the embodiments described above may be coupled to the accessory device 200 unless this is technically and clearly infeasible.

Referring to FIGS. 3A, 3B, 3C, 3D, 3E, and 3F, the accessory device 200 according to an embodiment may include at least a portion of the first housing 210, the second housing 220, and the fastening assembly 250.

In an embodiment, the first housing 210 may accommodate the electronic device 50. The electronic device 50 may be mounted on the first housing 210 in a state in which the display module 55 (e.g., the display module 160 of FIG. 1) is capable of being visually exposed to the outside. The first housing 210 may include various configurations to assist in the use of the electronic device 50.

For example, the first housing 210 may include at least a portion of a charging hole 202 facing a connecting terminal (e.g., the connecting terminal 178 of FIG. 1) of the electronic device 50, a plurality of sound holes 203a and 203b facing a sound output device (e.g., the sound output module 155 of FIG. 1) of the electronic device 50, a camera hole 204 facing a sensor module (e.g., the sensor module 176 of FIG. 1) or a camera (e.g., the camera module 180 of FIG. 1) of the electronic device 50, a support area 205 for supporting an external device such as an electronic fan connectable to the electronic device 50, a power button 206 for controlling a power source of the electronic device 50, and a volume button 207 for controlling volume.

In an embodiment, the first housing 210 may include the first case 211 and the second case 215 and may include the hinge 213 connecting the first case 211 to the second case 215.

In an embodiment, the first case 211 may accommodate a partial area (e.g., an upper end portion or a partial area in a +Z direction) of the electronic device 50. The second case 215 may accommodate another area (e.g., a lower end portion, a partial area in a −Z direction, or another area except for a portion accommodated by the first case 211) of the electronic device 50.

In an embodiment, the hinge 213 may connect the first case 211 to the second case 215 such that at least one of the first case 211 and the second case 215 may rotate about a hinge axis (e.g., an X-axis). For example, the first case 211 may be fixed to the electronic device 50, and the second case 215 may be separated from the electronic device 50 and rotated.

In an embodiment, the second housing 220 may accommodate the electronic module 230. The first housing 210 may be detachably fastened to the second housing 220 by the fastening assembly 250. For example, one end portion (e.g., a +Y-axis end portion) of the second housing 220 may be connected to an end portion (e.g., a −Z-axis end portion) of the second case 215 of the first housing 210.

In an embodiment, the fastening assembly 250 may include components provided in each of the first housing 210 and the second housing 220. For example, each of the connecting portions of the first housing 210 and the second housing 220 may be provided with fastening configurations (e.g., an adhesive material, a bracket, or a hinge structure) so that the first housing 210 and the second housing 220 may be detachably interconnected. Without being limited thereto, the fastening assembly 250 may be implemented in the form of components that are provided outside the first housing 210 and the second housing 220 and connected to each of the first housing 210 and the second housing 220.

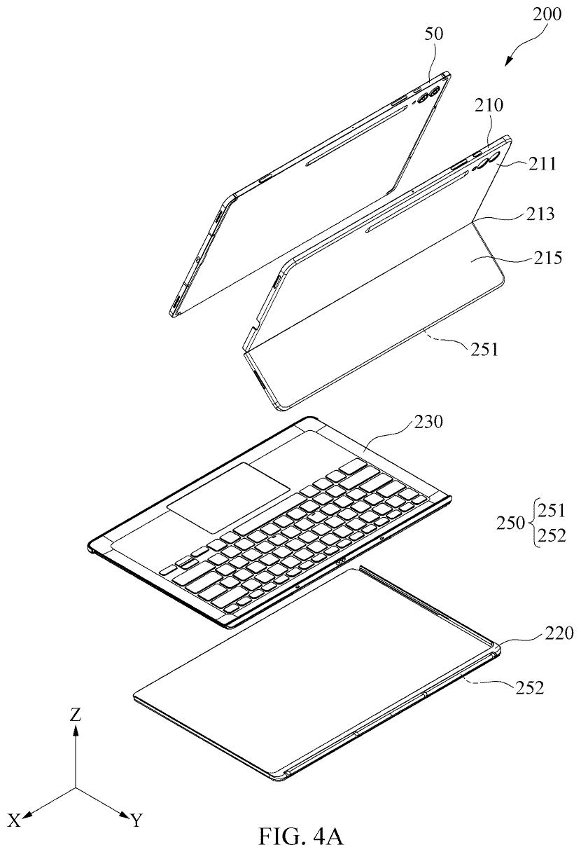

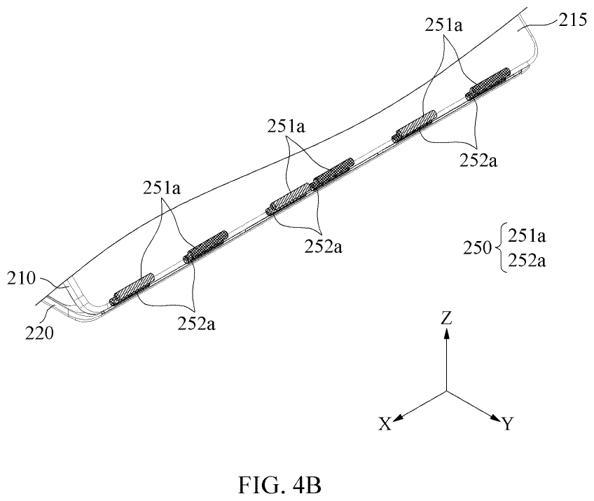

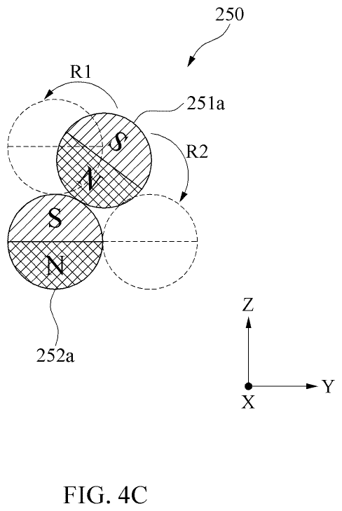

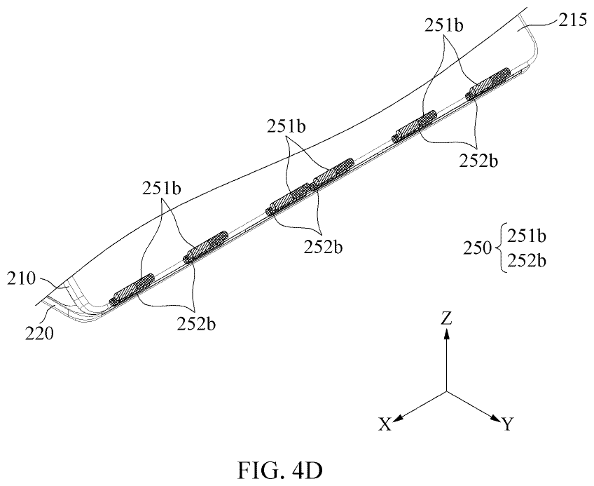

In an embodiment, the fastening assembly 250 may include at least one magnet. For example, the fastening assembly 250 may be implemented in the form of a magnet (e.g., a first magnet 251 of FIG. 4A) provided in the first housing 210 and a magnet (e.g., a second magnet 252 of FIG. 4A) provided in the second housing 220.

In an embodiment, the accessory device 200 may be modified in various ways in a state of being fastened to the electronic device 50. Hereinafter, one state of the electronic device 50 and the accessory device 200 is described with reference to FIGS. 3A, 3B, 3C, 3D, 3E, and 3F.

In an embodiment, as illustrated in FIG. 3A, the accessory device 200 in one state (e.g., a folding state) may accommodate the display module 55 of the electronic device 50 inside the accessory device 200, and the first housing 210 and the second housing 220 of the accessory device 200 may overlap and face each other.

For example, the display module 55 of the electronic device 50 may be covered by the second housing 220 and may not be visually exposed to the outside. The folding state may be a situation in which the electronic device 50 or the accessory device 200 is not in use, a charging situation, or a situation in which the electronic device 50 is used without viewing the display module 55 (e.g., recording, videotaping, or connecting to an external device).

In an embodiment, as illustrated in FIG. 3B, the accessory device 200 in one state (e.g., an intermediate state) may be open such that at least partial areas of the first housing 210 and the second housing 220 are moved away from each other in the folding state. One end portion of the electronic module 230 may slide while connected to the electronic device 50.

For example, the fastening assembly 250 may rotate the first housing 210 or the second housing 220 at a predetermined angle while connecting one end portion of the first housing 210 to one end portion of the second housing 220. The hinge 213 may rotate the second case 215 at a predetermined angle while connecting one end portion of the first case 211 to one end portion of the second case 215 and may separate the second case 215 from the electronic device 50. In the intermediate state, at least partial areas of the display module 55 of the electronic device 50 and the electronic module 230 may be visually exposed to the outside, and the electronic module 230 may slide and protrude from the second housing 220 by a predetermined length.

In an embodiment, as illustrated in FIG. 3C, the accessory device 200 in one state (e.g., an unfolding state or open state) may visually expose the display module 55 of the electronic device 50 to the outside of the accessory device 200.

For example, the fastening assembly 250 may maintain a state in which the first housing 210 or the second housing 220 is rotated at a predetermined angle while connecting one end portion of the first housing 210 to one end portion of the second housing 220. The hinge 213 may maintain a state in which the second case 215 is rotated at a predetermined angle while connecting one end portion of the first case 211 to one end portion of the second case 215. In the unfolding state, the display module 55 of the electronic device 50 and the electronic module 230 may be visually exposed to the outside in a usable state, and the electronic module 230 may be slid and maintained in a state protruding from the second housing 220. In the unfolding state, a user may use the electronic device 50 and the accessory device 200 by disposing the electronic device 50 and the accessory device 200 in an external support (e.g., a desk, a table, or a floor).

In an embodiment, as illustrated in FIG. 3D, in the accessory device 200 in one state (e.g., a separated state), the first housing 210 may be separated from the second housing 220, and the electronic device 50 may be separated from the electronic module 230.

In an embodiment, the components of the fastening assembly 250 provided in each of the first housing 210 and the second housing 220 may be separated from each other, thereby separating one end portion of each of the first housing 210 and the second housing 220. For example, the first housing 210 may be provided with a first magnet (e.g., a first magnet 251 of FIG. 4A), and the second housing 220 may be provided with a second magnet (e.g., a second magnet 252 of FIG. 4A).

In an embodiment, the user may store, move, or use the first housing 210 and the second housing 220 by separating the first housing 210 from the second housing 220. The user may separate a first magnet 251 from a second magnet 252 by providing, to the first housing 210 or the second housing 220, force or more force for overcoming the magnetic force of the first magnet 251 and the second magnet 252.

In an embodiment, one end portion (e.g., an +Y axis end portion) of the electronic module 230 may be provided with a first terminal 235a and a second terminal 235b, which are connected to the electronic device 50. In the separated state, the first terminal 235a and the second terminal 235b of the electronic module 230 may be separated from the electronic device 50.

In an embodiment, as illustrated in FIG. 3E, in the accessory device 200 in one state (e.g., a protective case state) the first housing 210 may be separated from the second housing 220. The first case 211 and the second case 215 may accommodate the electronic device 50 and protect the electronic device 50.

For example, in the protective case state, the user may hold the electronic device 50 in the hand to use or use the electronic device 50 by mounting the electronic device 50 on an external support or in the hand while lying down, and if needed, the user may store, move, or use the accessory device 200 and the electronic device 50 except for the second housing 220 and the electronic module 230.

In an embodiment, as illustrated in FIG. 3F, in the accessory device 200 in one state (e.g., a standing state), the first housing 210 may be separated from the second housing 220, the first case 211 may accommodate a partial area of the electronic device 50, and the second case 215 may be separated from the electronic device 50. For example, the user may separate or couple the second case 215 from or to the electronic device 50 by operating a switch 269.

In an embodiment, the accessory device 200 in a standing state may protect and mount the electronic device 50. For example, in the standing state, the user may use the electronic device 50 by mounting the electronic device 50 on an external support.

As described above, the accessory device 200 according to an embodiment of the present disclosure may be coupled to the electronic device 50 and modified into various states. The user may change the use of the accessory device 200 if needed and store, move, or use the electronic device 50 and the accessory device 200. Hereinafter, the configuration and structure of the accessory device 200 according to an embodiment are described with reference to the drawings, which are, however, merely examples of implementations and may be modified in various ways, but embodiments are not limited thereto.

FIG. 4A is an exploded perspective view of the electronic device 50 and the accessory device 200, according to an embodiment.

Hereinafter, the description provided above is not repeated, and in some embodiments, a portion of the configuration and structure of the accessory device 200 may be replaced, added, or omitted as will be easily understandable by one of ordinary skill in the art with reference to the following drawings and descriptions. In addition, at least one component or feature of the embodiments described above may be coupled to the accessory device 200 unless this is technically and clearly infeasible.

Referring to FIG. 4A, the fastening assembly 250 according to an embodiment may include the first magnet 251 and the second magnet 252.

In an embodiment, the fastening assembly 250 may include at least one magnet. For example, the fastening assembly 250 may be implemented in the form of the first magnet 251 provided in the first housing 210 and the second magnet 252 provided in the second housing 220. Without being limited thereto, at least one of the components of the fastening assembly 250 may be replaced with at least one of a metallic material or an electromagnet.

Herein, the terms ‘first magnet 251’ and ‘second magnet 252’ are merely names set according to the position where the first magnet 251 and the second magnet 252 are disposed, and simply referring to ‘magnet’ may indicate at least one of the first magnet 251 and the second magnet 252 of the fastening assembly 250.

In an embodiment, the first magnet 251 may be provided in one end portion (e.g., a −Z axis end portion) facing the hinge 213 in the second case 215. One end portion of the second case 215 may be connected to the second housing 220 through the fastening assembly 250, and the other end portion (e.g., a +Z axis end portion) may be connected to the first case 211 through the hinge 213.

In an embodiment, the first magnet 251 may be provided in plurality, and the plurality of first magnets 251 may be arranged in one end portion (e.g., an end portion facing the hinge 213) of the second case 215 of the first housing 210. For example, the plurality of first magnets 251 may be arranged substantially in a row along one end portion of the second case 215.

In an embodiment, the second magnet 252 may be provided in plurality, and the plurality of second magnets 252 may be arranged in one end portion of the second housing 220 facing the plurality of first magnets 251, respectively. For example, the plurality of first magnets 251 may be arranged to substantially face the plurality of first magnets 251, respectively, along one end portion of the second housing 220.

In an embodiment, the plurality of first magnets 251 and/or the plurality of second magnets 252 may be spaced apart from each other. Attractive force may act on the first magnet 251 and the second magnet 252 facing each other. For example, the first magnet 251 and the second magnet 252 facing each other may be polarized in opposite directions. Alternatively, the first magnet 251 and the second magnet 252, which face each other, may have opposite polarities on their facing surfaces.

In an embodiment, the fastening assembly 250 including the plurality of first magnets 251 and the plurality of second magnets 252 may provide convenience to the user. Compared to a bracket or a hinge fastening method, the plurality of first magnets 251 and the plurality of second magnets 252 may mutually be pulled from each other by magnetic force within a predetermined distance so that the user may easily and intuitively separate or connect the first housing 210 from or to the second housing 220.

In an embodiment, the first magnet 251 and the second magnet 252 may be formed of magnetic materials or metallic materials of various shapes, sizes, and types. Hereinafter, with reference to FIGS. 4B, 4C, and 4D, the accessory device 200 including a first magnet 251a or 251b and a second magnet 252a or 252b in the cylindrical shape is described as an example of the first magnet 251 and the second magnet 252, but embodiments are not limited thereto. Additionally, the description of the first magnet 251a or 251b and the second magnet 252a or 252b below may be applied interchangeably with each other or may be applied to the first magnet 251 and the second magnet 252 according to an embodiment of the present disclosure, unless otherwise specifically stated.

FIG. 4B is an enlarged perspective view of the accessory device 200 according to an embodiment, and FIG. 4C is a schematic diagram illustrating a plurality of magnets of the accessory device 200, according to an embodiment.

Hereinafter, the description provided above is not repeated, and in some embodiments, a portion of the configuration and structure of the accessory device 200 may be replaced, added, or omitted as will be understandable by one of ordinary skill in the art with reference to the following drawings and descriptions. In addition, at least one component or feature of the embodiments described above may be coupled to the accessory device 200 unless this is technically and clearly infeasible.

Referring to FIGS. 4B and 4C, the fastening assembly 250 may include the first magnet 251a and the second magnet 252a.

In an embodiment, a plurality of first magnets 251a and/or a plurality of second magnets 252a may be spaced apart from each other. Hereinafter, for ease of description, the plurality of first magnets 251a is described as an example, but the description may be applied identically or similarly to the plurality of second magnets 252a.

In an embodiment, each of the plurality of first magnets 251a may be formed of a magnet in the cylindrical shape extending along one end portion of the second case 215 in a direction (e.g., an X-axis direction). As the plurality of first magnets 251a is implemented in the form of a magnet in the cylindrical shape, the rotational motion of the plurality of first magnets 251a may be implemented smoothly and intuitively, and the rotational motion of the first housing 210 and the second housing 220 may be implemented smoothly.

In an embodiment, the end portion where the plurality of first magnets 251a is arranged in the first housing 210 may be bent at a predetermined curvature or inclined at a predetermined angle. And/or, the end portion where the plurality of second magnets 252a is arranged in the second housing 220 may be bent at a predetermined curvature or inclined at a predetermined angle. When the shape of the surface that the first magnet 251a and the second magnet 252a faces each other is bent, the relative movement of the first magnet 251a and the second magnet 252a may be implemented smoothly, compared to a case in which an edge protrudes, and the accessory device 200 may be open smoothly.

In an embodiment, each of the plurality of first magnets 251a may be polarized in opposite directions along the circumferential direction of the cylindrical shape. The circumferential direction corresponds to a direction orthogonal to the height (longitudinal) direction of the cylindrical shape, such as the X-axis in FIG. 4C. For example, as illustrated in FIG. 4C, the first magnet 251a disposed in the cylindrical shape may be polarized in opposite directions along the circumferential direction, which lies in a cross-sectional plane perpendicular to the height (Z-axis) of the cylindrical shape.

In an embodiment, one of the plurality of first magnets 251a may be polarized in a direction opposite to that of another adjacent first magnet 251a. Additionally, one of the plurality of second magnets 252a may be polarized in a direction opposite to that of another adjacent second magnet 252a.

For example, as illustrated in FIG. 4B, among the plurality of first magnets 251a, the first magnet 251a disposed at the end in one direction (e.g., an +X direction) may have an S pole facing upward (e.g., a +Z direction) and an N pole facing downward (e.g., a −Z direction). In addition, another first magnet 251a disposed adjacent to the side surface (e.g., an −X direction) of the first magnet 251a at the end may have an N pole facing upward and an S pole facing downward.

In various embodiments of the present disclosure, the plurality of first magnets 251a may easily guide the coupling position of the first housing 210 and the second housing 220 by having different poles between adjacent first magnets 251a.

For example, when the poles of the adjacent first magnets 251a are the same, in a properly coupled state, another adjacent second magnet 252a may be connected, other than the opposite second magnet 252a. As the polarization directions of the plurality of first magnets 251a are alternately disposed, the fastening assembly 250 may guide the coupling position of the first housing 210 and the second housing 220, and the user may appropriately couple the first housing 210 to the second housing 220 by disposing the first housing 210 and the second housing 220 within a predetermined position range.

Referring to FIG. 4C, an example of a movement in which the first magnet 251a moves while rotating based on a fixed state of the second magnet 252a is described. However, in some embodiments, the first magnet 251a and the second magnet 252a may be spaced apart from each other.

In an embodiment, when the second housing 220 is mounted on an external support, the position of the second magnet 252a may be fixed, and the first magnet 251a may move the first housing 210 while rotating along the circumferential direction of the second magnet 252a.

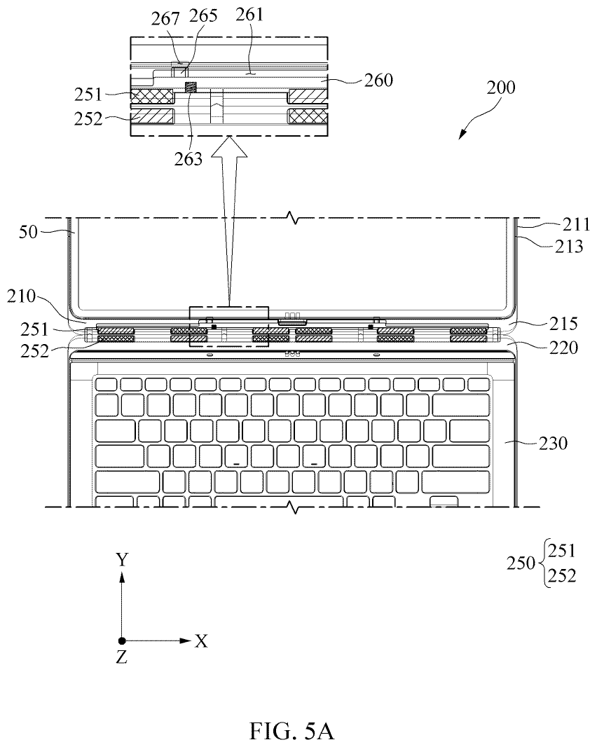

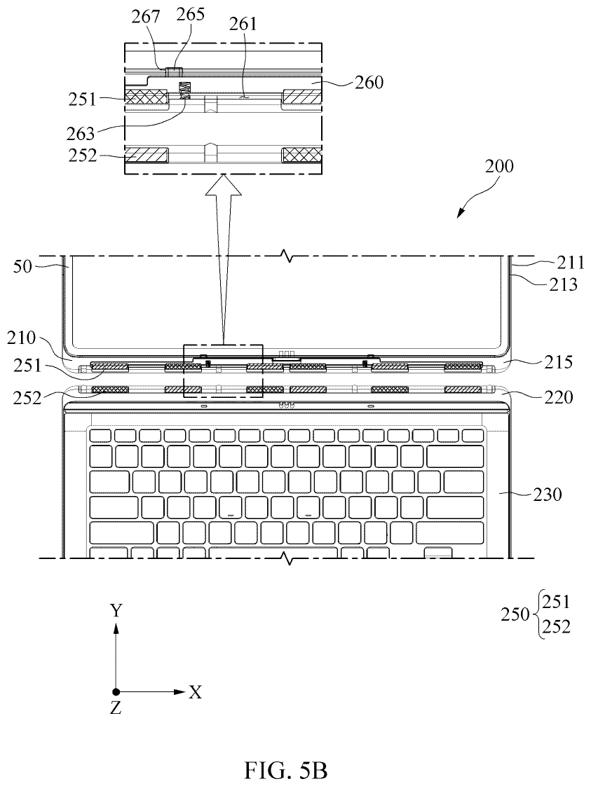

For example, referring to FIG. 4C, as the first magnet 251a moves in a first rotational direction R1, the first housing 210 and the second housing 220 may be changed to a folding state (e.g., the state of FIG. 3A). Alternatively, as the first magnet 251a moves in a second rotational direction R2, the first housing 210 and the second housing 220 may be changed to a horizontal state (e.g., a state of FIG. 5A) and may subsequently be changed to a separated state (e.g., the state of FIG. 3D).

In various embodiments of the present disclosure, each of the plurality of second magnets 252a may be formed of a magnet in the cylindrical shape extending along one end portion of the second housing 220 and may be polarized in both directions based on a cross-section horizontal to the height direction of the cylindrical shape. As the plurality of second magnets 252a has a structure and arrangement substantially the same as or similar to the plurality of first magnets 251a, the movement of the first housing 210 and the second housing 220 may be smooth and convenient.

FIG. 4D is an enlarged perspective view of an accessory device according to an embodiment.

Hereinafter, the description provided above is not repeated, and in some embodiments, a portion of the configuration and structure of the accessory device 200 may be replaced, added, or omitted as will be understandable by one of ordinary skill in the art with reference to the following drawings and descriptions. In addition, at least one component or feature of the embodiments described above may be coupled to the accessory device 200 unless this is technically and clearly infeasible.

Referring to FIG. 4D, the fastening assembly 250 according to an embodiment may include the first magnet 251b and the second magnet 252b.

In an embodiment, the plurality of first magnets 251b and/or the plurality of second magnets 252b may be spaced apart from each other. Hereinafter, for ease of description, the plurality of first magnets 251b is described as an example, but the description may be applied equally or similarly to the plurality of second magnets 252b.

In an embodiment, each of the plurality of first magnets 251b may be formed in a cylindrical shape extending along one end portion of the second case 215 in a direction corresponding to the circumferential direction (e.g., the X-axis). Each of the plurality of first magnets 251b may be polarized in opposite directions along the circumferential direction within a cross-sectional plane that is perpendicular to the height direction (Z-axis) of the cylindrical shape.

In an embodiment, one of the plurality of first magnets 251b may be polarized in the same direction as another adjacent first magnet 251b. Additionally, one of the plurality of second magnets 252b may be polarized in the same direction as another adjacent second magnet 252b.

For example, as illustrated in FIG. 4D, among the plurality of first magnets 251b, the first magnet 251b disposed at the end in one direction (e.g., an +X direction) may have an S pole facing one side (e.g., an +X direction) and an N pole facing the other side (e.g., an −X direction). In addition, another first magnet 251b disposed adjacent to the other side (e.g., an −X direction) of the first magnet 251b at the end may have an N pole facing one side and an S pole facing the other side.

In various embodiments of the present disclosure, the plurality of first magnets 251b may have the same pole between adjacent first magnets 251b so that the magnetic force acting between the plurality of first magnets 251b and the plurality of second magnets 252b may be relatively stronger.

FIGS. 5A and 5B are plan views of the accessory device 200 equipped with the electronic device 50, according to an embodiment.

Hereinafter, the description provided above is not repeated, and in some embodiments, a portion of the configuration and structure of the accessory device 200 may be replaced, added, or omitted as will be understandable by one of ordinary skill in the art with reference to the following drawings and descriptions. In addition, at least one component or feature of the embodiments described above may be coupled to the accessory device 200 unless this is technically and clearly infeasible.

Referring to FIGS. 5A and 5B, the first housing 210 of the accessory device 200 according to an embodiment may include at least a portion of a guide member 260, a guide groove 261, an elastic member 263, and a locking member 265.

In an embodiment, at least a portion of the plurality of first magnets 251 may be fixed to the guide member 260. In FIGS. 5A and 5B, all the plurality of first magnets 251 is described as being fixed to the guide member 260 and moving together, but embodiments are not limited thereto, and at least one first magnet 251 may be fixed to the guide member 260.

In an embodiment, the guide groove 261 may accommodate the guide member 260. Inside the guide groove 261, the guide member 260 may be disposed to be movable in a first direction (e.g., a +Z direction) toward one end portion of the second case 215 or in a second direction (e.g., a −Z direction) opposite to the first direction.

In an embodiment, the guide member 260 may be moved inside the guide groove 261 by the magnetic force of the plurality of first magnets 251. For example, as illustrated in FIG. 5A, in a state in which the first housing 210 is connected to the second housing 220, the first magnet 251 and the second magnet 252 may be pulled from each other by the attractive force, and the guide member 260 may move in a direction toward the second magnet 252 together with the first magnet 251 within the guide groove 261, that is, in the second direction.

In an embodiment, the elastic member 263 may be pressed when the guide member 260 moves in the first direction. The elastic member 263 may assist the movement of the guide member 260. The guide member 260 may be moved inside the guide groove 261 by the elastic force of the elastic member 263.

For example, as illustrated in FIG. 5B, in a state in which the first housing 210 and the second housing 220 are separated, the elastic member 263 may push the guide member 260, and the guide member 260 may move in the first direction within the guide groove 261.

In an embodiment, the accessory device 200 may predict and utilize the connection state of the first housing 210 and the second housing 220 based on the movement of the guide member 260. For example, the locking member 265 may be connected to the guide member 260, and the locking member 265 may fix or release the electronic device 50 and the second case 215 based on the movement of the guide member 260.

In an embodiment, the locking member 265 may move linearly in the first direction or the second direction together with the guide member 260 and may be separated from a locking groove 267 or inserted into the locking groove 267 provided in the electronic device 50. However, this is only an example of driving, and the locking member 265 may be implemented to be rotatable or tiltable and may be selectively engaged with the electronic device 50.

In an embodiment, as illustrated in FIG. 5A, when the guide member 260 is moved in the first direction by at least a portion of the plurality of first magnets 251, the locking member 265 may release the fixation of the electronic device 50 and the second case 215.

For example, when the fixation of the electronic device 50 and the second case 215 is released in a state in which the first housing 210 and the second housing 220 are connected, the second case 215 may be separated from the electronic device 50, so the accessory device 200 may be open, such as an intermediate state (e.g., the state of FIG. 3B) or an unfolding state (e.g., the state of FIG. 3C) of the accessory device 200.

In an embodiment, as illustrated in FIG. 5B, when the guide member 260 is moved in the second direction by the elastic member 263, the locking member 265 may fix the electronic device 50 and the second case 215.

For example, when the electronic device 50 and the second case 215 are fixed in a state in which the first housing 210 and the second housing 220 are separated, the second case 215 may accommodate the electronic device 50, so the accessory device 200 may protect the electronic device 50, such as a protective case state (e.g., the state of FIG. 3E) of the accessory device 200.

In various embodiments of the present disclosure, the guide member 260 and the locking member 265 may be moved in conjunction with the movement of the first housing 210 and the second housing 220 by the magnetic force of the fastening assembly 250 and/or the elastic force of the elastic member 263, and using this, the accessory device 200 may provide convenience to the user.

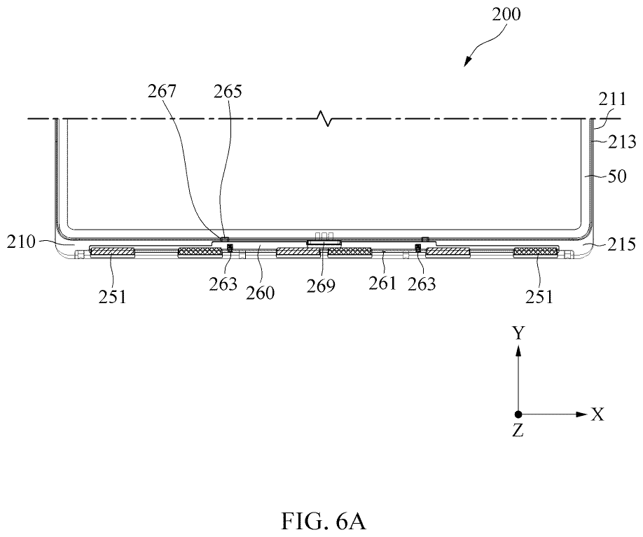

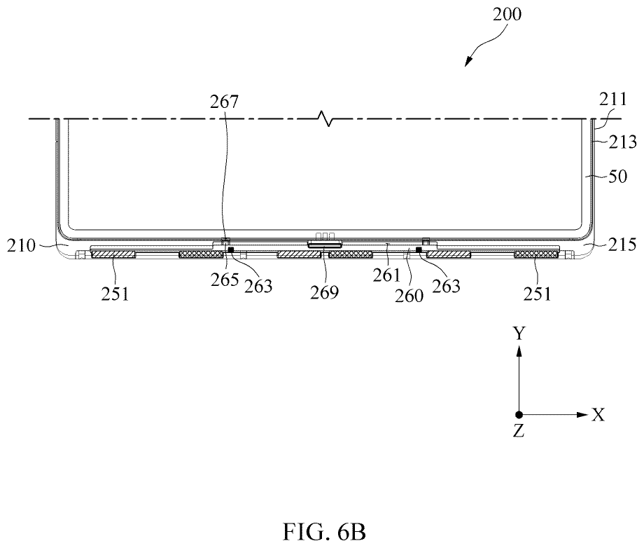

FIGS. 6A and 6B are plan views of the accessory device 200 equipped with the electronic device 50, according to an embodiment.

Hereinafter, the description provided above is not repeated, and in some embodiments, a portion of the configuration and structure of the accessory device 200 may be replaced, added, or omitted as will be understandable by one of ordinary skill in the art with reference to the following drawings and descriptions. In addition, at least one component or feature of the embodiments described above may be coupled to the accessory device 200 unless this is technically and clearly infeasible.

Referring to FIGS. 6A and 6B, the first housing 210 of the accessory device 200 according to an embodiment may include the switch 269.

In an embodiment, the switch 269 may move the guide member 260. The switch 269 may be switched by external force (e.g., a user's operation). The electronic device 50 or the accessory device 200 may electronically drive the switch 269 and move the guide member 260.

In an embodiment, the switch 269 may control the guide member 260 to move inside the guide groove 261 in a state in which the first housing 210 is separated from the second housing 220.

For example, by pressing the switch 269, the user may change the state of the accessory device 200 from the state of FIG. 6A in which the second case 215 is mounted on the electronic device 50 to the state of FIG. 6B in which the second case 215 is separated from the electronic device 50.

In an embodiment, by separating the second case 215 from the state of FIG. 6B, the user may change the accessory device 200 from a protective case state (e.g., the state of FIG. 3E) to a standing state (e.g., the state of FIG. 3F).

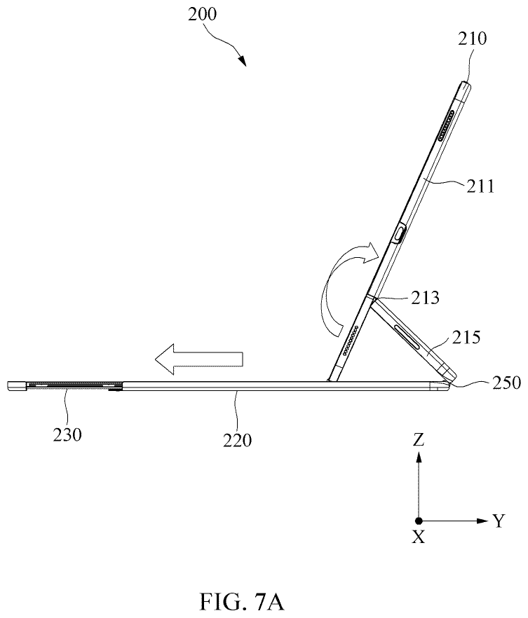

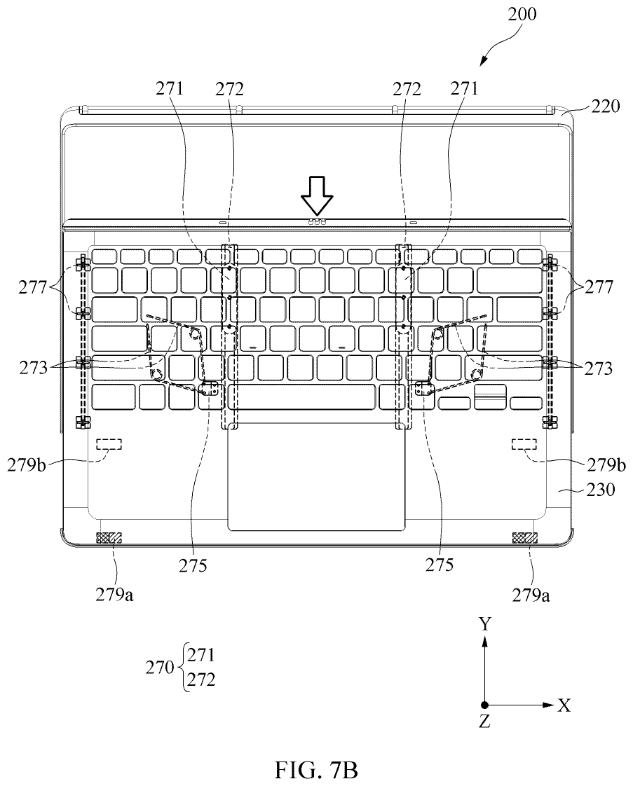

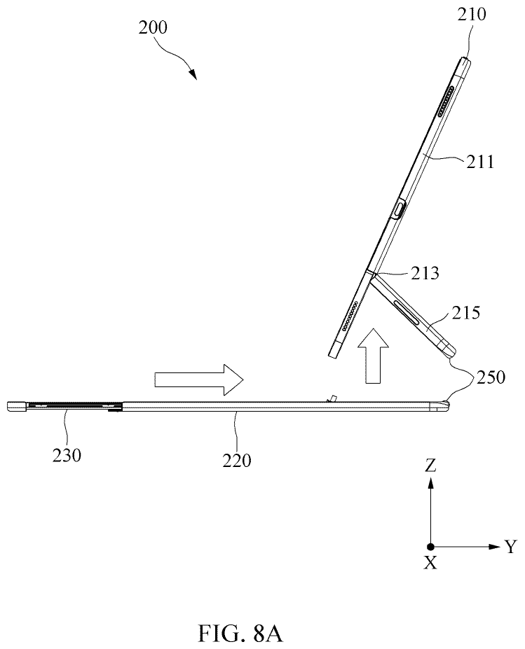

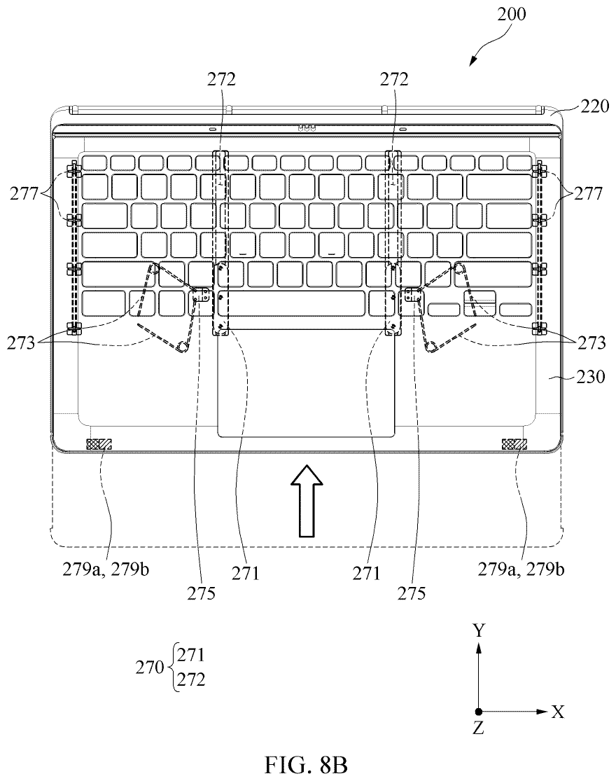

FIG. 7A is a side view of the accessory device 200 equipped with the electronic device 50, according to an embodiment, and FIG. 7B is a plan view of the second housing 220 according to an embodiment. In addition, FIG. 8A is a side view of the accessory device 200 equipped with the electronic device 50, according to an embodiment, and FIG. 8B is a plan view of the second housing 220 according to an embodiment.

Specifically, FIGS. 7A and 7B are diagrams illustrating the driving in which the electronic module 230 slides as the accessory device 200 is open in a state in which the electronic device 50 is coupled to the accessory device 200, and FIGS. 8A and 8B are diagrams illustrating the driving in which the electronic module 230 slides as the electronic device 50 is separated from the accessory device 200.

Hereinafter, the description provided above is not repeated, and in some embodiments, a portion of the configuration and structure of the accessory device 200 may be replaced, added, or omitted as will be understandable by one of ordinary skill in the art with reference to the following drawings and descriptions. In addition, at least one component or feature of the embodiments described above may be coupled to the accessory device 200 unless this is technically and clearly infeasible.

Referring to FIGS. 7A, 7B, 8A, and 8B, the accessory device 200 according to an embodiment may include at least a portion of a slide assembly 270, a restoring member 273, a plurality of wheels 277, a first sub-magnet 279a, and a second sub-magnet 279b.

In an embodiment, the slide assembly 270 may support the electronic module 230 to slide in a slide direction (e.g., a −Y direction) from one end portion in which the plurality of second magnets 252 is arranged toward the other end portion opposite thereto or the opposite direction (e.g., an +Y direction). The slide assembly 270 may include a fixing member 271 and a guide rail 272.

In an embodiment, the fixing member 271 may be provided in the second housing 220. The fixing member 271 may be provided at a fixed position in the second housing 220. The fixing member 271 may protrude from the second housing 220 and guide the slide motion of the guide rail 272.

In an embodiment, the guide rail 272 may be provided in the electronic module 230. The guide rail 272 may accommodate the fixing member 271 protruding from the second housing 220. The guide rail 272 may have a shape extending in the slide direction.

In an embodiment, the electronic module 230 may slide in a state in which the guide rail 272 and the fixing member 271 are connected or interoperated. The fixing member 271 may limit or guide the movement range and/or movement direction of the electronic module 230. The electronic module 230 may be smoothly slid by the slide assembly 270 only in a predetermined direction.

As illustrated in FIGS. 7B and 8B, the fixing member 271 may be provided in plurality in the inner side surface of the second housing 220, and the guide rail 272 may be provided corresponding to the fixing member 271 in the lower side surface of the electronic module 230. Without being limited thereto, the positions of the fixing member 271 and the guide rail 272 may be changed in various ways, for example, the fixing member 271 may be provided in the electronic module 230 and the guide rail 272 may be provided in the second housing 220 so that the slide assembly 270 may guide the slide motion of the electronic module 230.

In an embodiment, the restoring member 273 may be formed of an elastic material and may be pressed when the electronic module 230 moves in the slide direction. When the first housing 210 is separated from a state in which the electronic module 230 is slid, the restoring member 273 may provide restoring force for restoring the electronic module 230 to a position before being slid.

In an embodiment, one end portion of the restoring member 273 may be fixed to a support panel 275 of the electronic module 230, and the other end portion of the restoring member 273 may be fixed to the second housing 220. When the electronic module 230 is slid, the restoring member 273 may be modified and elastic force may act. For example, the restoring member 273 of FIG. 7B may be in a state in which the electronic module 230 is slid and pressed to be tensioned, and the restoring member 273 of FIG. 8B may be in a state in which the electronic module 230 is returned and contracted.

In an embodiment, the restoring member 273 may assist the electronic module 230 to be automatically restored when the first housing 210 is separated and may provide convenience to the user. In addition, in a state in which the electronic module 230 is slid, when the first housing 210 is separated, there may be a possibility that foreign materials may flow between the first housing 210 and the electronic module 230. When the first housing 210 is separated, the restoring member 273 may automatically restore the electronic module 230 and prevent foreign materials from flowing between the first housing 210 and the electronic module 230.

In an embodiment, the plurality of wheels 277 may be provided between the second housing 220 and the electronic module 230. The plurality of wheels 277 may support the electronic module 230 to be spaced apart from the second housing 220 at a predetermined interval.

In an embodiment, the plurality of wheels 277 may reduce the frictional force between the second housing 220 and the electronic module 230. For example, each of the plurality of wheels 277 may include a bearing member. Through the rotational movement of the plurality of wheels 277, the electronic module 230 of the accessory device 200 may slide smoothly.

In an embodiment, the first sub-magnet 279a and the second sub-magnet 279b may support the electronic module 230 in a state in which the first housing 210 is separated. The first sub-magnet 279a may be provided in the electronic module 230, and the second sub-magnet 279b may be provided in the second housing 220.

In an embodiment, the second sub-magnet 279b may be disposed to face the first sub-magnet 279a based on a state (e.g., the state of FIG. 8B) before the electronic module 230 is slid.

In an embodiment, the first sub-magnet 279a and the second sub-magnet 279b may be disposed such that poles opposite to each other face each other. Attractive force may act in a state in which the first sub-magnet 279a faces the second sub-magnet 279b. The first sub-magnet 279a and the second sub-magnet 279b may limit the movement of the electronic module 230 and/or guide the restored position of the electronic module 230.

In an embodiment, the first sub-magnet 279a and the second sub-magnet 279b may support the electronic module 230 and the second housing 220, prevent the electronic module 230 from arbitrarily sliding, and prevent foreign materials from flowing between the first housing 210 and the electronic module 230.

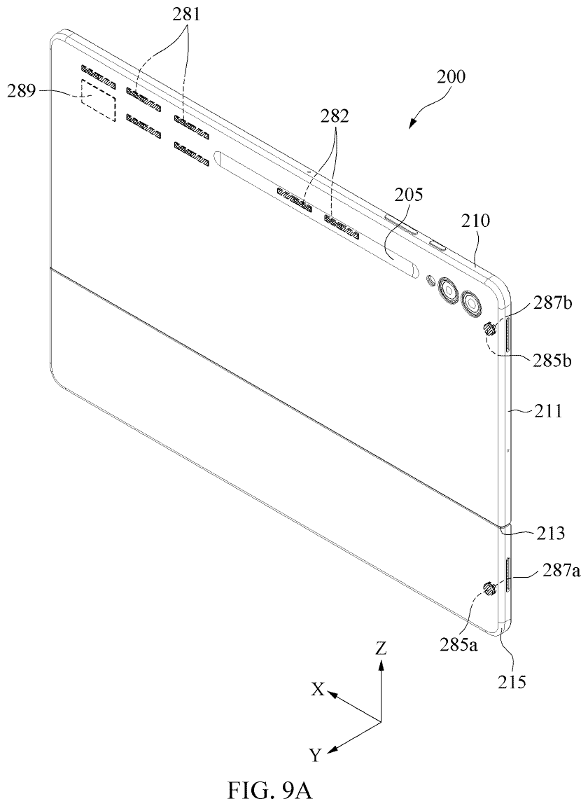

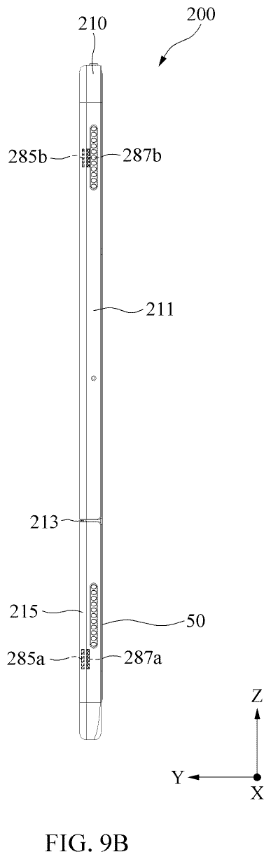

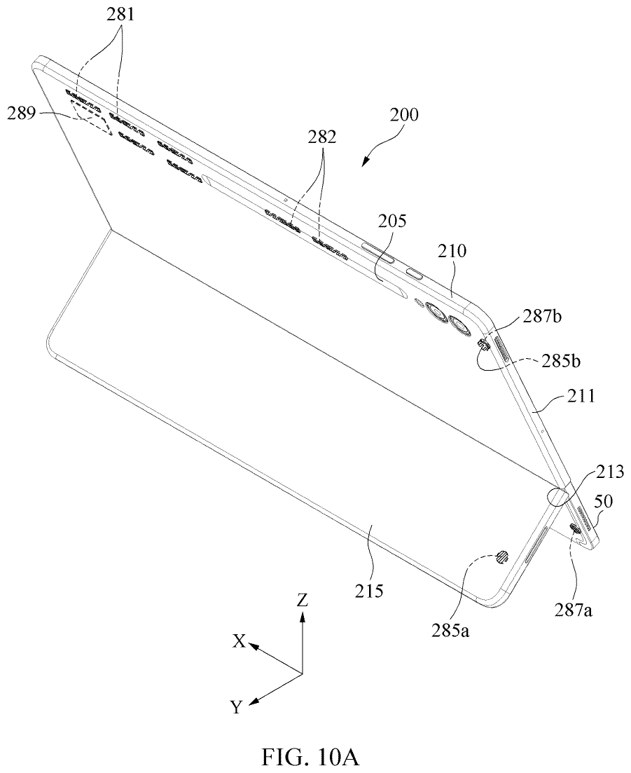

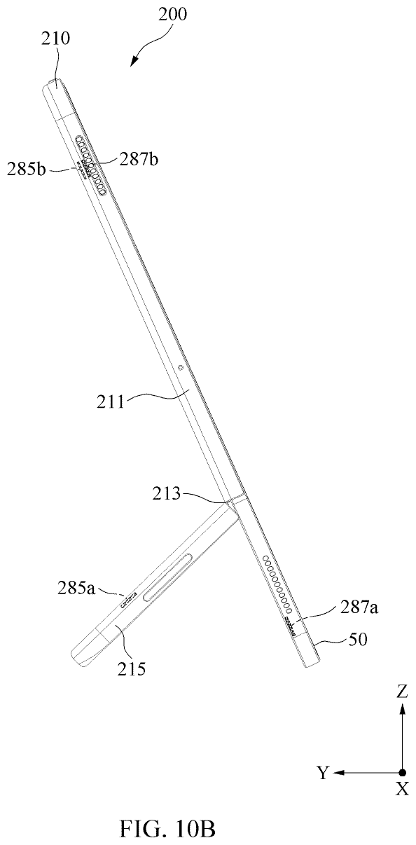

FIG. 9A is a rear view of the accessory device 200 equipped with the electronic device 50, according to an embodiment, and FIG. 9B is a side view of the accessory device 200 according to an embodiment. In addition, FIG. 10A is a rear view of the accessory device 200 equipped with the electronic device 50, according to an embodiment, and FIG. 10B is a side view of the accessory device 200 according to an embodiment.

Specifically, FIGS. 9A and 9B are diagrams illustrating a rear surface and a side surface of the electronic device 50 and the accessory device 200 in a protective case state (e.g., the state of FIG. 3E), and FIGS. 10A and 10B are diagrams illustrating a rear surface and a side surface of the electronic device 50 and the accessory device 200 in a standing state (e.g., the state of FIG. 3F).

Hereinafter, the description provided above is not repeated, and in some embodiments, a portion of the configuration and structure of the accessory device 200 may be replaced, added, or omitted as will be understandable by one of ordinary skill in the art with reference to the following drawings and descriptions. In addition, at least one component or feature of the embodiments described above may be coupled to the accessory device 200 unless this is technically and clearly infeasible.

Referring to FIGS. 9A, 9B, 10A, and 10B, the accessory device 200 according to an embodiment may include at least a portion of a first fastening assembly 281, a second fastening assembly 282, at least one marker 285a or 285b, and an antenna module 289.

In an embodiment, the first fastening assembly 281 may be provided in a surface facing the electronic device 50 in the first case 211. The first fastening assembly 281 may be formed of a magnetic material and may support the electronic device 50. For example, the electronic device 50 may include a magnetic body, a metal material, or an electromagnet provided at a position opposite to the first fastening assembly 281.

In an embodiment, the second fastening assembly 282 may support an external auxiliary connecting device (e.g., an electronic fan connectable to the electronic device 50). The second fastening assembly 282 may be formed of a magnetic material and may be provided in the support area 205 of the first case 211.

In an embodiment, the marker 285a or 285b may be provided in one surface of the first housing 210 and may change electromagnetically depending on the distance from the electronic device 50. For example, the marker 285a or 285b may be disposed to face a receiver provided in the electronic device 50.

In an embodiment, the marker 285a or 285b may be provided in plurality, and the plurality of markers 285a and 285b may include a first marker 285a and a second marker 285b. The receiver may be provided in plurality corresponding to a marker of an accessory housing, and the plurality of receivers may include a first receiver 287a and a second receiver 287b.

In an embodiment, when the distance between the first and second markers 285a and 285b and the first and second receivers 287a and 287b increases or decreases, the electromagnetic field between the first and second markers 285a and 285b and the first and second receivers 287a and 287b changes, and based on this, the electronic device 50 may detect a change in state of the first housing 210.

For example, the first marker 285a may be provided in the second case 215, and the first receiver 287a may be provided at a position facing the first marker 285a. The first marker 285a may move in conjunction with the movement of the second case 215 and may move away from or closer to the first receiver 287a. When the distance between the first marker 285a and the first receiver 287a changes, an electromagnetic change between the first marker 285a and the first receiver 287a may occur. The first receiver 287a may detect the movement state of the second case 215 based on the electromagnetic change.

For example, the second marker 285b may be provided in the first case 211, and the second receiver 287b may be provided at a position facing the second marker 285b. The second marker 285b may move away from or closer to the second receiver 287b depending on whether the first housing 210 and the electronic device 50 are detached. When the distance between the second marker 285b and the second receiver 287b changes, an electromagnetic change between the second marker 285b and the second receiver 287b may occur. The second receiver 287b may detect the detachment state of the electronic device 50 and the first housing 210 based on the electromagnetic change.

In an embodiment, the electronic device 50 may provide an optimized user experience (UX) to the user or change the usage status based on various pieces of information interoperating with the accessory device 200.

In an embodiment, the antenna module 289 may wirelessly communicate with the electronic device 50 and provide, to the electronic device 50, information about the connection and state of the electronic device 50 and the accessory device 200.

In an embodiment, the antenna module 289 may detect an electromagnetic change in the first fastening assembly 281 and/or the second fastening assembly 282. The antenna module 289 may detect the connection state of the electronic device 50 and/or the auxiliary connecting device, and the electronic device 50 may provide an optimized UX to the user through the information received from the antenna module 289.

In an embodiment, the antenna module 289 may detect an electromagnetic change of the first marker 285a and/or the second marker 285b. The antenna module 289 may detect the connection state between the electronic device 50 and the first housing 210, and the electronic device 50 may provide an optimized UX to the user through the information received from the antenna module 289.

An accessory device 200 detachable from an electronic device 50, according to an embodiment, may include a first housing 210 including a first case 211 capable of accommodating a partial area of the electronic device 50, a second case 215 capable of accommodating another area of the electronic device 50, and a hinge 213 configured to rotatably connect the first case 211 to the second case 215, a second housing 220 including an electronic module 230 connectable to the electronic device 50, and a fastening assembly 250 configured to detachably couple the first housing 210 to the second housing 220. The fastening assembly 250 may include, in the second case 215, a plurality of first magnets 251 arranged in one end portion facing the hinge 213, and in one end portion of the second housing 220, a plurality of second magnets 252 arranged to face the plurality of first magnets 251, respectively.

In an embodiment, the plurality of first magnets 251 may be spaced apart from each other. In an embodiment, one of the plurality of first magnets 251 may be polarized in a direction opposite to another adjacent one.

In an embodiment, each of the plurality of first magnets 251 may be formed of a magnet in a cylindrical shape extending along one end portion of the second case 215.

In an embodiment, each of the plurality of first magnets 251a may be polarized in both directions based on a cross-section horizontal to a height direction of the cylindrical shape.

In an embodiment, each of the plurality of first magnets 251b may be polarized in both directions based on a cross-section perpendicular to the height direction of the cylindrical shape.

In an embodiment, the first housing 210 may include a guide member 260 to which at least a portion of the plurality of first magnets 251 is fixed and a guide groove 261 configured to accommodate the guide member 260. In an embodiment, inside the guide groove 261, the guide member 260 may be disposed to be movable in a first direction toward the one end portion of the second case 215 or a second direction opposite to the first direction.

In an embodiment, the first housing 210 may include an elastic member 263 that is pressed when the guide member 260 moves in the first direction and a locking member 265 connected to the guide member 260 and configured to fix or release the electronic device 50 and the second case 215 based on a movement of the guide member 260.

In an embodiment, the locking member 265 may be configured to release a fixation of the electronic device 50 and the second case 215 when the guide member 260 is moved by at least a portion of the plurality of first magnets 251 in the first direction. In an embodiment, the locking member 265 may be configured to fix the electronic device 50 and the second case 215 when the guide member 260 is moved by the elastic member 263 in the second direction.

In an embodiment, the first housing 210 may include a switch 269 configured to move the guide member 260.

In an embodiment, the accessory device 200 may further include a slide assembly 270 configured to support the electronic module 230 to be slidable in a slide direction from one end portion in which the plurality of second magnets 252 is disposed toward another end portion opposite thereto or in an opposite direction. In an embodiment, the slide assembly 270 may include a fixing member 271 provided in the second housing 220 and a guide rail 272 provided in the electronic module 230, configured to accommodate the fixing member 271, and extending in the slide direction.

In an embodiment, the second housing 220 may further include a restoring member 273 that is pressed when the electronic module 230 moves in the slide direction and is formed of an elastic material.

In an embodiment, the accessory device 200 may further include a plurality of wheels 277 provided between the second housing 220 and the electronic module 230.

In an embodiment, the electronic module 230 may include a first sub-magnet 279a. The second housing 220 may include a second sub-magnet 279b disposed to face the first sub-magnet 279a based on a state before the electronic module 230 slides.

In an embodiment, the first housing 210 may further include a first fastening assembly 281 provided in a surface facing the electronic device 50 in the first case 211 and configured to support the electronic device 50 and a second fastening assembly 282 configured to support an external auxiliary connecting device.

In an embodiment, the accessory device 200 may further include at least one marker 285a, 285b provided in the second case 215 and configured to electromagnetically change according to a distance from the electronic device 50.

In addition, an accessory device 200 detachable from an electronic device 50, according to an embodiment, may include a first case 211 capable of accommodating a partial area of the electronic device 50, a second case 215 capable of accommodating another area of the electronic device 50, a hinge 213 configured to rotatably connect the first case 211 to the second case 215, and in the second case 215, a plurality of magnets e.g., first magnets 251 arranged in one end portion facing the hinge 213. In an embodiment, the plurality of magnets 251 may be spaced apart from each other, and one of the plurality of magnets 251 may be polarized in a direction opposite to another adjacent one.

In an embodiment, each of the plurality of magnets 251 may be formed of a magnet in a cylindrical shape extending along one end portion of the second case 215.

In an embodiment, each of the plurality of magnets 251a may be polarized in both directions based on a cross-section horizontal to a height direction of the cylindrical shape.

In an embodiment, the accessory device 200 may further include a guide member 260 to which at least a portion of the plurality of magnets 251 is fixed and a guide groove 261 configured to accommodate the guide member 260. In an embodiment, inside the guide groove 261, the guide member 260 may be disposed to be movable in a first direction toward the one end portion of the second case 215 or a second direction opposite to the first direction.

In an embodiment, the accessory device 200 may further include an elastic member 263 that is pressed when the guide member 260 moves in the first direction and a locking member 265 connected to the guide member 260 and configured to fix or release the electronic device 50 and the second case 215 based on a movement of the guide member 260. In an embodiment, the locking member 265 may release a fixation of the electronic device 50 and the second case 215 when the guide member 260 is moved by at least a portion of the plurality of magnets 251 in the first direction. In an embodiment, the locking member 265 may fix the electronic device 50 and the second case 215 when the guide member 260 is moved by the elastic member 263 in the second direction.

Each of the embodiments provided in the above description is not excluded from being associated with one or more features of another example or another embodiment also provided herein or not provided herein but consistent with the disclosure.

While embodiments have been illustrated and described above, the present disclosure is not limited to the aforementioned specific embodiments. Those skilled in the art should appreciate that various modifications may be made to the embodiments without departing from the subject matter of the present disclosure as defined by the appended claims, and also that such modifications are not to be understood individually from the technical spirit or prospect of the present disclosure.

What is claimed is:

1. An accessory device that is detachable from an electronic device, the accessory device comprising:
a first housing comprising a first case configured to accommodate a first portion of the electronic device, a second case configured to accommodate a second portion of the electronic device, and a hinge rotatably connecting the first case to the second case;
a second housing comprising an electronic module configured to be connected to the electronic device; and
a fastening assembly configured to detachably couple the first housing to the second housing,
wherein the fastening assembly comprises:
a plurality of first magnets arranged in a first end portion of the second case facing the hinge; and
a plurality of second magnets in a first end portion of the second housing and respectively arranged to face the plurality of first magnets.

2. The accessory device of claim 1, wherein the plurality of first magnets are spaced apart from each other, and
wherein one of the plurality of first magnets is polarized in a direction opposite to an adjacent first magnet.

3. The accessory device of claim 1, wherein each of the plurality of first magnets comprises a magnet in a cylindrical shape extending along an end portion of the second case.

4. The accessory device of claim 3, wherein each of the plurality of first magnets is polarized in both directions based on a cross-section horizontal to a height direction of the cylindrical shape.

5. The accessory device of claim 3, wherein each of the plurality of first magnets is polarized in both directions based on a cross-section perpendicular to a height direction of the cylindrical shape.

6. The accessory device of claim 1, wherein the first housing comprises:
a guide member to which at least a portion of the plurality of first magnets is fixed; and
a guide groove configured to accommodate the guide member, and
wherein, inside the guide groove, the guide member is disposed to be movable in a first direction toward the first end portion of the second case or a second direction opposite to the first direction.

7. The accessory device of claim 6, wherein the first housing comprises:
an elastic member configured to be pressed when the guide member moves in the first direction; and
a locking member connected to the guide member and configured to fix or release the electronic device and the second case based on movement of the guide member.

8. The accessory device of claim 7, wherein the locking member is further configured to:
release a fixation of the electronic device and the second case when the guide member is moved by at least one of the plurality of first magnets in the first direction; and
fix the electronic device and the second case when the guide member is moved by the elastic member in the second direction.

9. The accessory device of claim 7, wherein the first housing comprises a switch configured to move the guide member.

10. The accessory device of claim 1, further comprising:
a slide assembly configured to support the electronic module to be slidable in a slide direction from a first end portion of the accessory device in which the plurality of second magnets is disposed toward a second end portion of the accessory device opposite to the first end portion or in an opposite direction,
wherein the slide assembly comprises:
a fixing member in the second housing; and
a guide rail in the electronic module, configured to accommodate the fixing member, and extending in the slide direction.

11. The accessory device of claim 10, wherein the second housing further comprises a restoring member configured to be pressed when the electronic module moves in the slide direction, the restoring member comprising an elastic material.

12. The accessory device of claim 10, further comprising:
a plurality of wheels between the second housing and the electronic module.

13. The accessory device of claim 10, wherein the electronic module comprises a first sub-magnet, and
wherein the second housing comprises a second sub-magnet configured to face the first sub-magnet based on a state before the electronic module slides.

14. The accessory device of claim 1, wherein the first housing further comprises:
a first fastening assembly in a surface facing the electronic device in the first case and configured to support the electronic device; and
a second fastening assembly configured to support an external auxiliary connecting device.

15. The accessory device of claim 1, further comprising:
at least one marker in the second case and configured to electromagnetically change according to a distance from the electronic device.

16. An accessory device that is detachable from an electronic device, the accessory device comprising:
a first case configured to accommodate a first portion of the electronic device;
a second case configured to accommodate a second portion of the electronic device;
a hinge rotatably connecting the first case to the second case; and
a plurality of magnets in a first end portion of the second case facing the hinge,
wherein the plurality of magnets are spaced apart from each other, and
wherein a first magnet of the plurality of magnets is polarized in a direction opposite to a second magnet of the plurality of magnets that is adjacent to the first magnet.

17. The accessory device of claim 16, wherein each of the plurality of magnets comprises a magnet in a cylindrical shape extending along an end portion of the second case.

18. The accessory device of claim 17, wherein each of the plurality of magnets is polarized in both directions based on a cross-section horizontal to a height direction of the cylindrical shape.

19. The accessory device of claim 17, further comprising:
a guide member to which at least a portion of the plurality of magnets is fixed; and
a guide groove configured to accommodate the guide member,
wherein, inside the guide groove, the guide member is disposed to be movable in a first direction toward the first end portion of the second case or a second direction opposite to the first direction.

20. The accessory device of claim 19, further comprising:
an elastic member configured to be pressed when the guide member moves in the first direction; and
a locking member connected to the guide member and configured to fix or release the electronic device and the second case based on a movement of the guide member,
wherein the locking member is further configured to:
release a fixation of the electronic device and the second case when the guide member is moved by at least one of the plurality of magnets in the first direction; and
fix the electronic device and the second case when the guide member is moved by the elastic member in the second direction.
